(19) United States
(12) Patent Application Publication
(10) Pub. No.: US 2013/0255027 A1
(43) Pub. Date: Oct. 3, 2013

(54) CLEANING APPLIANCE WITH ADAPTOR

(71) Applicant: George M. Burns, Peoria, AZ (US)

(72) Inventor: George M. Burns, Peoria, AZ (US)

(21) Appl. No.: 13/433,165

(22) Filed: Mar. 28, 2012

(51) Int. Cl. A47L 11/00; B23P 11/00; A47L 7/00

(52) U.S. Cl. 15/320; 29/428

(57) ABSTRACT

A hard surface cleaning appliance is disclosed. The hard surface cleaning appliance includes a cleaning head with a top surface and a bottom surface. The bottom surface is adjacent a surface to be cleaned. The cleaning head disperses cleaning fluid onto the surface to be cleaned, and subsequently vacuums up the cleaning fluid and dirt from the surface to the cleaned. The hard surface cleaning appliance includes an adaptor. Adjusting the adaptor adjusts the amount of pressure the cleaning head exerts on the surface to be cleaned. Having the capability to adjust the amount of pressure the cleaning head exerts on the surface to be cleaned allows the cleaning appliance to work on uneven surfaces such as tile, brick, or stone without the cleaning head getting stuck in cracks or crevices in the surface to be cleaned.

### CROSS REFERENCE TO RELATED APPLICATION

This application is related to U.S. Pat. No. 6,370,728 to George M. Burns, which is incorporated entirely herein by reference.

### BACKGROUND OF THE INVENTION

1. Technical Field

This invention relates generally to cleaning appliances, and more specifically to a hard surface cleaning appliance.

2. State of the Art

Hard surface cleaning appliances are in popular use today by consumers for cleaning tile and wood floors, for example. U.S. Pat. No. 6,370,728, provides details of a hard surface cleaning appliance that supplies cleaning liquid to a surface to be cleaned, and removes the liquid and dirt from the surface after the surface has been cleaned with the liquid. While this appliance works well for many hard surfaces, there are some hard surfaces which have a surface texture that is uneven, making it difficult to move the cleaning appliance easily across the uneven surface. Surfaces such as brick or textured concrete, for example, sometimes have surface variations and textures that are quite dramatic. When a hard surface cleaning appliance is used on these surfaces, the cleaning head can get stuck in grooves or surface variations and be hard to maneuver. Thus it is desirable to have a hard surface cleaning appliance that can be easily maneuvered across uneven surfaces so that these surfaces can be cleaned by the cleaning appliance.

### DISCLOSURE OF THE INVENTION

The disclosed invention relates to cleaning appliances, and more specifically to a hard surface cleaning appliance.

Disclosed is a hard surface cleaning appliance including a cleaning head with a top surface and a bottom surface. The bottom surface is adjacent a surface to be cleaned. The hard surface cleaning appliance includes a first attachment ear coupled to the top surface, a second attachment ear coupled to the top surface, and an adaptor coupled to the first attachment ear and the second attachment ear. The amount of pressure applied to the surface to be cleaned by the bottom surface is adjusted by adjusting the adaptor. In some embodiments the adaptor comprises a first side bar coupled to the first attachment ear, a second side bar coupled to the second attachment ear, and one or more than one cross member bar, wherein the one or more than one cross member bar couples the first side bar to the second side bar.

In some embodiments the hard surface cleaning appliance also includes a first wheel coupled to the first side bar with a first height adjustable coupler, a second wheel coupled to the first side bar with a second height adjustable coupler, a third wheel coupled to the second side bar with a third height adjustable coupler, and a fourth wheel coupled to the second side bar with a fourth height adjustable coupler. The adaptor is adjusted in response to adjusting the height of any of the first, second, third or fourth height adjustable couplers. In some embodiments the hard surface cleaning appliance includes a handle, wherein the handle includes a first handle bar, wherein the first handle bar is coupled to the first attachment ear, and a second handle bar, wherein the second handle bar is coupled to the second attachment ear. In some embodiments the first handle bar and the first side bar are coupled to opposing surfaces of the first attachment ear. In some embodiments the second handle bar and the second side bar are coupled to opposing surfaces of the second attachment ear. In some embodiments the first handle bar and the first side bar are coupled to opposing surfaces of the first attachment ear using a lynch pin, wherein the lynch pin extends through the first side bar, through the first attachment ear, and through the first handle bar.

Disclosed is a cleaning appliance with dual use attachment ears. The cleaning appliance can be used in a first mode in which the handle is attached to one or more than one attachment ear. In some embodiments the handle includes a first handle bar coupled to a first attachment ear and a second handle bar coupled to a second attachment ear. The cleaning appliance can be used in a second mode in which an adaptor is coupled to the one or more than one attachment ear, wherein adjusting the adaptor adjusts the amount of pressure a cleaning head of the cleaning appliance exerts on a surface to be cleaned. In the second mode the one or more than one attachment ears are used to couple both the handle and the adaptor to the cleaning head. In some embodiments the handle and the adaptor are coupled to opposing sides of an attachment ear. In some embodiments a first handle bar is coupled to a first attachment ear inner surface, and a first side bar of the adaptor is coupled to a first attachment ear outer surface. In some embodiments a second handle bar is coupled to a second attachment ear inner surface, and a second side bar of the adaptor is coupled to a second attachment ear outer surface.

A cleaning appliance is disclosed, where the cleaning appliance includes a cleaning head with a top surface, and a bottom surface. The bottom surface is adjacent a surface to be cleaned. The cleaning appliance also includes an adaptor coupled to the top surface. The adaptor includes a frame, one or more than one wheel, and one or more than one height adjustable coupler. Each of the one or more than one wheels is coupled to the frame using a corresponding one of the one or more than one height adjustable couplers. Adjusting any of the one or more than one height adjustable couplers adjusts the amount of pressure the bottom surface applies to the surface to be cleaned. In some embodiments the cleaning head includes a first attachment ear and a second attachment ear where the adaptor is coupled to a first attachment ear outer surface, and wherein the adaptor is also coupled to a second attachment ear outer surface.

In some embodiments the cleaning appliance includes a first handle bar, where the first handle bar is coupled to a first attachment ear inner surface, and a second handle bar, where the second handle bar is coupled to a second attachment ear inner surface. In some embodiments the frame includes a first side bar, a second side bar, and a cross member, where the cross member couples the first side bar to the second side bar. In some embodiments at least one of the one or more than one height adjustable couplers includes a threaded rod, where the threaded rod extends through the first side bar, a first and a second nut, where the height of the first side bar above the surface to be cleaned is adjusted in response to adjusting the first and the second nut, an axle, where one of the wheels is coupled to the axle, and a wheel cover assembly, where the wheel cover assembly couples the axle to the threaded rod.

Disclosed is a method of forming a hard surface cleaning appliance. The method includes the steps of forming a cleaning head including an attachment ear, forming a handle, where the handle attaches to the attachment ear, and forming an adaptor, where the adaptor couples to the attachment ear. In some embodiments the step of forming a cleaning head including an attachment ear includes the step of coupling an attachment ear to a top surface of the cleaning head. In some embodiments the step of forming a cleaning head including an attachment ear includes the step of coupling a first and a second attachment ear to the top surface of the cleaning head.

The foregoing and other features and advantages of the present invention will be apparent from the following more detailed description of the particular embodiments of the invention, as illustrated in the accompanying drawings.

### BRIEF DESCRIPTION OF THE DRAWINGS

FIG. 1 shows an embodiment of cleaning appliance 110 according to the invention.

FIG. 2 shows an exploded view of cleaning appliance 110 of FIG. 1.

FIG. 3 shows a top view of cleaning head 112 and adaptor 180 of cleaning appliance 110 of FIG. 1, showing how lynch pin 190 and hair pin cotter 191 couple adaptor 180 to cleaning head 112.

FIG. 4 shows a side view of wheel 210 and height adjustable coupler 224 of adaptor 180 of cleaning appliance 110 of FIG. 1, showing how height adjustable coupler 224 adjusts the height of side bar 184 above surface to be cleaned 130, which adjusts the amount of pressure that bottom surface 154 exerts on surface to be cleaned 130.

FIG. 5 illustrates method 310 of forming a hard surface cleaning appliance.

### DETAILED DESCRIPTION OF EMBODIMENTS OF THE INVENTION

As discussed above, embodiments of the disclosed invention relate to cleaning appliances, and more specifically to a hard surface cleaning appliance. Specifically an adaptor has been designed which can be retrofitted for use with the hard surface cleaning appliance described in U.S. Pat. No. 6,370,728 to George M. Burns and other similar hard surface cleaning appliances. The adaptor improves the ability of the cleaning appliance to clean hard surfaces with grooves or other surface variations. The adaptor can be supplied as an accessory to newly purchased hard surface cleaning appliances, or can be retrofitted to older models as an aftermarket device.

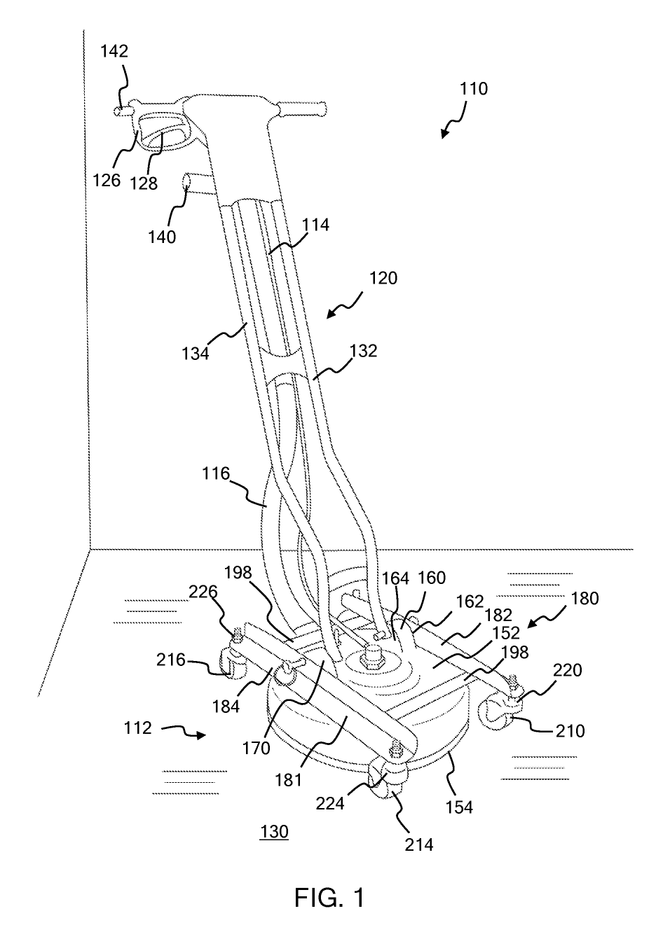

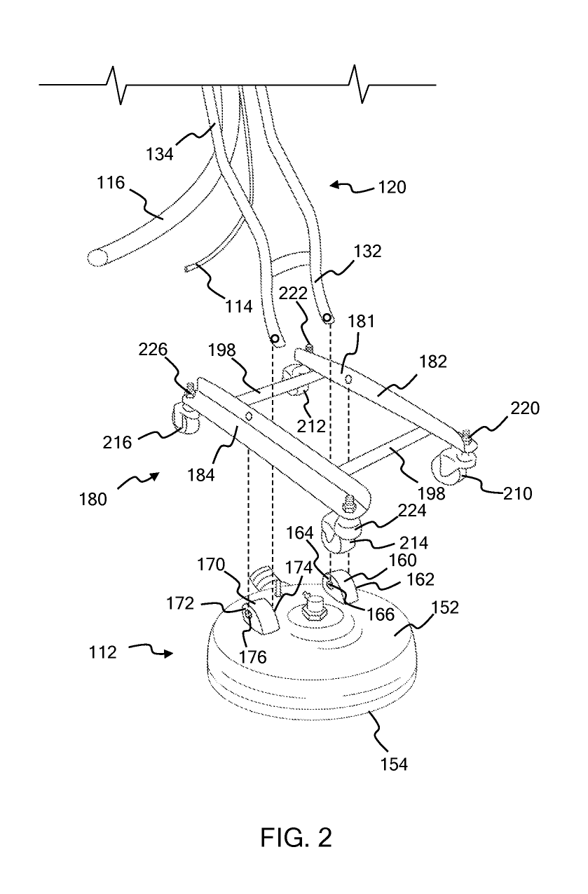

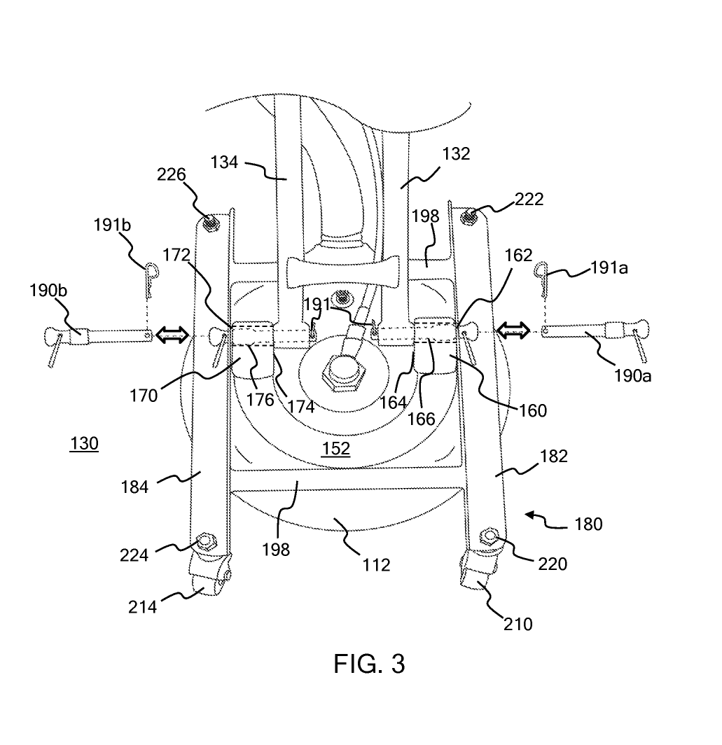

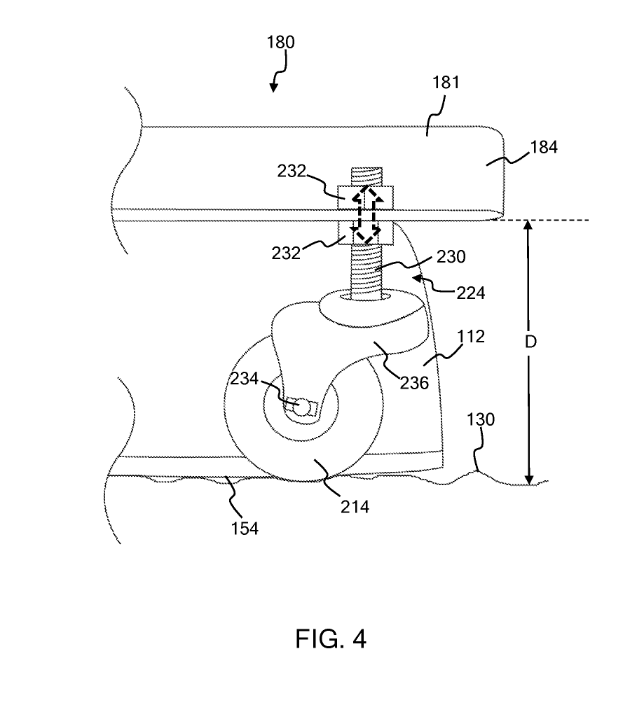

FIG. 1 through FIG. 4 illustrate one embodiment of hard surface cleaning appliance 110 according to the invention. FIG. 1 shows a perspective view of cleaning appliance 110 according to the invention. FIG. 2 shows an exploded view of the bottom portion of handle 120, adaptor 180 and cleaning head 112. FIG. 3 shows a top view of cleaning head 112 and adaptor 180. FIG. 4 shows a side cutaway portion of cleaning head 112 showing wheel 214 and height adjustable coupler 224.

Cleaning appliance 110 according to the invention can be used to clean hard surfaces 130 such as tile, wood floors, laminate floors, concrete floors, pool decks, brick or stone surfaces, or any other hard surface. Cleaning appliance 110 according to the invention includes cleaning head 112, adaptor 180, and handle 120. Cleaning head 112 receives cleaning fluid through liquid supply line 114 and liquid supply fitting 142. Cleaning head 112 disperses the cleaning fluid onto surface to be cleaned 130. Cleaning head 112 receives vacuum through vacuum hose 116. Cleaning appliance 110 sucks cleaning fluid and dirt from surface to be cleaned 130 out through vacuum supply hose 116 and vacuum supply line 140. Handle grip 126 of handle 120 includes trigger lever 128 which allows the operator of hard surface cleaning appliance 110 to control the supply of cleaning fluid to cleaning head 112 and surface to be cleaned 130.

Cleaning appliance 110 includes cleaning head 112 and adaptor 180. Cleaning head 112 includes top surface 152 and bottom surface 154, as shown in FIG. 1 through FIG. 4. Bottom surface 154 is adjacent surface to be cleaned 130. Adaptor 180 is removeably coupled to cleaning head 112 top surface 152 in this embodiment. In some embodiments adaptor 180 is coupled to other parts of cleaning head 112. Adaptor 180 adjusts the amount of pressure that bottom surface 154 applies to surface to be cleaned 130, as will be explained in more detail shortly. In the embodiment shown adaptor 180 is removeably coupled to first attachment ear 160 and second attachment ear 170. First attachment ear 160 and second attachment ear 170 are coupled to top surface 152 of cleaning head 112 in this embodiment. An attachment ear is a protrusion, extension, bump, knob, projection, or other piece of cleaning head 112 that can be used to attach to. An attachment ear can be removeably coupled to cleaning head 112, can be permanently coupled to cleaning head 112, or can be formed as an integral part of cleaning head 112.

Adaptor 180 is what allows cleaning appliance 110 to easily clean textured surfaces such as tile, stone and concrete with uneven surfaces. Adaptor 180 adjusts the pressure that cleaning head 112 exerts on surface to be cleaned 130. In this embodiment adaptor 180 transfers some of the pressure that cleaning head 112 exerts on surface to be cleaned 130 from bottom surface 154 to adaptor 180—in this embodiment to wheels 210, 212, 214, and 216 as shown. Wheels 210, 212, 214, and 216 can easily roll along textured surfaces. Bottom surface 154 would tend to get stuck in any dents and crevices that may exist in surface to be cleaned 130. Adaptor 180 adjusts the amount of pressure that bottom surface 154 exerts on surface to be cleaned 130, allowing cleaning head 112 and bottom surface 154 to slide easily across surface to be cleaned 130. Thus adaptor 180 provides cleaning appliance 110 according the invention the means to clean surfaces that are not smooth, where other hard surface cleaning appliances would get hung up on the surface texture features. Adaptor 180 can be supplied as an accessory to a cleaning appliance 110 according to the invention that is purchased new, or adaptor 180 can be sold as an aftermarket part to be used with an older cleaning appliance that includes cleaning head 112 and handle 120.

Adaptor 180 in this embodiment includes frame 181, wheels 210, 212, 214, and 216, and height adjustable couplers 220, 222, 224, and 226 as shown in the figures. In some embodiments adaptor 180 has other forms. In the embodiment shown in FIG. 1 through FIG. 4, frame 181 supports the weight of cleaning head 112 on wheels 210, 212, 214, and 216. Wheels 210, 212, 214, and 216 are removeably coupled to frame 181 using height adjustable couplers 220, 222, 224, and 226 respectively. FIG. 4 shows an example of how wheel 214 is removeably coupled to frame 181 using height adjustable coupler 224. In this embodiment height adjustable coupler 220 includes threaded rod 230, nuts 232, wheel cover assembly 236, and axle 234. Wheel 214 rides on axle 234, which is coupled to threaded rod 230 by wheel cover assembly 236. Threaded rod 230 extends vertically from wheel cover assembly 236 and runs through side bar 184 of frame 181. Nuts 232 are placed above and below side bar 184 on threaded rod 230. Adjusting nuts 232 up and down on threaded rod 230 adjusts the height D of side bar 184 above surface to be cleaned 130 (see FIG. 4). Adjusting height D of side bar 184 above surface to be cleaned 130 adjusts the amount of pressure that bottom surface 154 exerts on surface to be cleaned 130. In this way adjusting height adjustable coupler 224 of adjustor 180 adjusts the amount of pressure that bottom surface 154 of cleaning head 112 exerts on surface to be cleaned 130. Wheels 210, 212, 216, and height adjustable couplers 220, 222, and 226 work similarly to that shown in FIG. 4 and explained above. Height adjustable couplers 220, 222, 224, and 226 can be adjusted to be the same height or different heights in this embodiment, depending on the configuration of surface to be cleaned 130. Adjusting any of height adjustable couplers 220, 222, 224, or 226 of adaptor 180 will adjust the amount of pressure that bottom surface 154 exerts on surface to be cleaned 130.

In the embodiment of cleaning appliance 110 shown in FIG. 1 through FIG. 4, frame 181 includes first side bar 182, second side bar 184 and cross members 198. Cross members 198 couple first side bar 182 to second side bar 184. Two cross members 198 are shown but there can be any number of cross members 198. In some embodiments frame 181 has other forms. Frame 181 can take any form needed to support cleaning head 112 and allow adjustment of the amount of pressure exerted by bottom surface 154 on surface to be cleaned 130. In the embodiment shown, first side bar 182 is removeably coupled to outer surface 162 of first ear 160, and second side bar 184 is removeably coupled to outer surface 172 of second attachment ear 170. In this embodiment first and second wheels 210 and 212 are removeably coupled to opposing ends of first side bar 182 using first and second height adjustable couplers 220 and 222. First and second height adjustable couplers 220 or 222 can be adjusted such that first side bar 182 is parallel to surface to be cleaned 130 or such that first side bar 182 is at an angle with respect to surface to be cleaned 130, depending on the surface features and desired cleaning effects. Adjusting either or both of first and second height adjustable couplers 220 or 222 adjusts the amount of pressure that bottom surface 154 exerts on surface to be cleaned 130.

In this embodiment third and fourth wheels 214 and 216 are removeably coupled to opposing ends of second side bar 184 using third and fourth height adjustable couplers 224 and 226. Third and fourth height adjustable couplers 224 or 226 can be adjusted such that second side bar 184 is parallel to surface to be cleaned 130 or such that second side bar 184 is at an angle with respect to surface to be cleaned 130, depending on the surface features and desired cleaning effects. Adjusting either or both of third and fourth height adjustable couplers 224 or 226 adjusts the amount of pressure that bottom surface 154 exerts on surface to be cleaned 130.

Adaptor 180 is removeably coupled to cleaning head 112 in this embodiment using first and second attachment ears 160 and 170. First attachment ear 160 has first attachment ear outer surface 162 and first attachment ear inner surface 164. In this embodiment first attachment ear outer surface 162 and first attachment ear inner surface 164 are opposing surfaces. In this embodiment adaptor 180 is removeably coupled to first attachment ear outer surface 162 of first attachment ear 160 as shown in FIG. 1, FIG. 2, and FIG. 3. In this embodiment frame 181 of adaptor 180 is removeably coupled to first attachment ear outer surface 162 of first attachment ear 160. In this embodiment first side bar 182 of frame 181 is removeably coupled to first attachment ear outer surface 162 of first attachment ear 160. In some embodiments adaptor 180 is coupled to first attachment ear 160 using other attachment devices or methods. In some embodiments adaptor 180 is coupled to cleaning head 112 using other attachment means.

Second attachment ear 170 has second attachment ear outer surface 172 and second attachment ear inner surface 174. In this embodiment second attachment ear outer surface 172 and second attachment ear inner surface 174 are opposing surfaces. In this embodiment adaptor 180 is removeably coupled to second attachment ear outer surface 172 of second attachment ear 170 as shown in FIG. 1, FIG. 2, and FIG. 3. In this embodiment frame 181 of adaptor 180 is removeably coupled to second attachment ear outer surface 172 of second attachment ear 170. In this embodiment second side bar 184 of frame 181 is removeably coupled to second attachment ear outer surface 172 of second attachment ear 170. In some embodiments adaptor 180 is coupled to second attachment ear 170 using other attachment devices or methods. In some embodiments adaptor 180 is coupled to cleaning head 112 using other attachment means.

Cleaning appliance 110 in this embodiment includes handle 120. Handle 120 in this embodiment includes first handle bar 132 and second handle bar 134. First handle bar 132 and second handle bar 134 are removeably coupled to cleaning head 112. First handle bar 132 is removeably coupled to first attachment ear 160. Second handle bar 134 is removeably coupled to second attachment ear 170. In this embodiment adaptor 180 and handle 120 are both coupled to first attachment ear 160. In this embodiment adaptor 180 and handle 120 are both coupled to second attachment ear 170. In this embodiment first side bar 182 and first handle bar 132 are both coupled to first attachment ear 160. In this embodiment second side bar 184 and second handle bar 134 are both coupled to second attachment ear 170.

First handle bar 132 is removeably coupled to first attachment ear inner surface 164. First side bar 182 is removeably coupled to first attachment ear outer surface 164. First attachment ear inner surface 162 and first attachment ear outer surface 164 are opposing surfaces in this embodiment. Thus, in this embodiment, first handle bar 132 and first side bar 182 are coupled to opposing surfaces of first attachment ear 160. First handle bar 132 and first side bar 182 are coupled to first attachment ear 160 using lynch pin 190a and hair pin cotter 191a as shown in FIG. 3. Lynch pin 190a passes through a hole in first side bar 182, then through hole 166 in first attachment ear 160, where hole 166 runs from outer surface 162 to inner surface 164, and then through a hole in first handle bar 132. Hair pin cotter 191a is then placed through a hole in the end of lynch pin 190a to hold lynch pin 190a in place. Lynch pin 190a couples first side bar 182 to first attachment ear outer surface 162. Lynch pin 190a couples first handle bar 132 to first attachment ear inner surface 164. Lynch pin 190a couples adaptor 180 and handle 120 to first attachment ear 160 of cleaning head 112.

Second handle bar 134 is removeably coupled to second attachment ear inner surface 174. Second side bar 184 is removeably coupled to second attachment ear outer surface 172. Second attachment ear inner surface 172 and second attachment ear outer surface 174 are opposing surfaces in this embodiment. Thus, in this embodiment, second handle bar 134 and second side bar 184 are coupled to opposing surfaces of second attachment ear 170. Second handle bar 134 and second side bar 184 are coupled to second attachment ear 170 using lynch pin 190b and hair pin cotter 191b as shown in FIG. 3. Lynch pin 190b passes through a hole in second side bar 184, then through hole 176 in second attachment ear 170, where hole 176 runs from outer surface 172 to inner surface 174, and then through a hole in second handle bar 134. Hair pin cotter 191b is then placed through a hole in the end of lynch pin 190b to hold lynch pin 190b in place. Lynch pin 190b couples second side bar 184 to second attachment ear outer surface 172. Lynch pin 190b couples second handle bar 134 to second attachment ear inner surface 174. Lynch pin 190b couples adaptor 180 and handle 120 to second attachment ear 170 of cleaning head 112.

In the embodiments of cleaning appliance 110 shown in FIG. 1 through FIG. 4, attachment ears 160 and 170 are dual use attachment ears. In this embodiment cleaning appliance 110 can be used without adaptor 180. Adaptor 180 is an optional accessory that can be coupled to attachment ears 160 and 170 of cleaning head 112 when needed. In some embodiments cleaning head 112 and handle 120 were sold earlier and adaptor 180 is purchased as an aftermarket device. In some embodiments cleaning appliance 110 according to the invention is sold as a kit which includes cleaning head 112 with dual use attachment ears 160 and 170, handle 120, and adaptor 180. Cleaning appliance 110 in this embodiment can be used with or without adaptor 180. Cleaning appliance 110 can be used in a first mode in which handle 120 is attached to one or more than one attachment ear 160 or 170. In some embodiments handle 120 includes first handle bar 132 coupled to first attachment ear 160 and second handle bar 134 coupled to second attachment ear 170. Cleaning appliance 110 can be used in a second mode in which adaptor 180 is coupled to the one or more than one attachment ear 160 or 170, wherein adjusting the adaptor adjusts the amount of pressure cleaning head 112 of cleaning appliance 110 exerts on surface to be cleaned 130. In the second mode the one or more than one attachment ears 160 and 170 are used to couple both handle 120 and adaptor 180 to cleaning head 112. In some embodiments handle 120 and adaptor 180 are coupled to opposing sides of an attachment ear 160 or 170. In some embodiments first handle bar 132 is coupled to first attachment ear inner surface 164, and first side bar 182 of adaptor 180 is coupled to first attachment ear outer surface 162. In some embodiments second handle bar 134 is coupled to second attachment ear inner surface 174, and second side bar 134 of adaptor 180 is coupled to second attachment ear outer surface 172.

An improved cleaning appliance 110 has been described, where cleaning appliance 110 includes adaptor 180 which is used to adjust the amount of pressure that cleaning head 112 exerts on a surface to be cleaned 130. Being able to adjust the amount of pressure exerted on surface to be cleaned 130 allows cleaning appliance 110 to perform better on uneven surfaces. Cleaning appliance 110 using adaptor 180 cleans uneven surfaces easier without getting stuck or hung up on surface variations. Adaptor 180 can be supplied as a part of a complete cleaning appliance 110, or adaptor 180 can be retrofitted to an existing cleaning appliance because adaptor 180 is able to couple to the same attachment ears used to couple handle 120 to cleaning head 112.

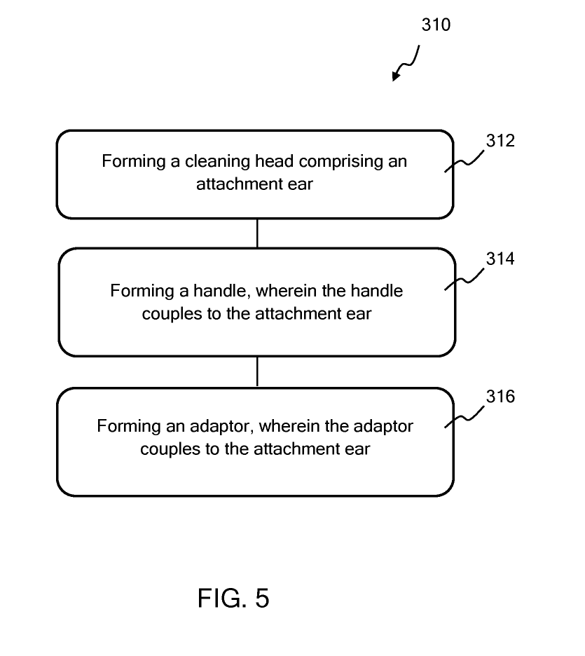

FIG. 5 illustrates method 310 of forming a hard surface cleaning appliance according to the invention. Method 310 according to the invention includes step 312 of forming a cleaning head comprising an attachment ear, step 314 of forming a handle, where the handle attaches to the attachment ear, and step 316 of forming an adaptor, where the adaptor couples to the attachment ear. Adjusting the adaptor adjusts the amount of pressure the cleaning head exerts on a surface to be cleaned. Method 310 can include many other steps.

Step 312 of forming a cleaning head that includes an attachment ear can include many other steps. In some embodiments step 312 includes coupling an attachment ear to the top surface of the cleaning head. In some embodiments step 312 includes coupling a first and a second attachment ear to the top surface of the cleaning head.

Step 314 of forming a handle, where the handle attaches to the attachment ear, can include many other steps. In some embodiments step 314 includes forming a handle with a first handle bar and a second handle bar. In some embodiments the first handle bar couples to an inner surface of the attachment ear. In some embodiments the second handle bar couples to an inner surface of a second attachment ear.

Step 316 forming an adaptor, where the adaptor couples to the attachment ear, can include many other steps. In some embodiments step 316 includes the step of forming a first and a second adaptor side bar. In some embodiments step 316 includes the step of coupling the first adaptor side bar to the second adaptor side bar with a first and a second cross member bar. In some embodiments step 316 includes the step of coupling a first wheel to the first adaptor bar with a first height adjustment coupler. In some embodiments step 316 includes the step of coupling a second wheel to the first adaptor bar with a second height adjustment coupler. In some embodiments step 316 includes the step of coupling a third wheel to the second adaptor bar with a third height adjustment coupler. In some embodiments step 316 includes the step of coupling a fourth wheel to the second adaptor bar with a fourth height adjustment coupler. In some embodiments the amount of pressure exerted on a surface to be cleaned by the cleaning head is adjusted in response to adjusting the first height adjustment coupler. In some embodiments the amount of pressure exerted on the surface to be cleaned by the cleaning head is adjusted in response to adjusting the second height adjustment coupler. In some embodiments the amount of pressure exerted on the surface to be cleaned by the cleaning head is adjusted in response to adjusting the third height adjustment coupler. In some embodiments the amount of pressure exerted on the surface to be cleaned by the cleaning head is adjusted in response to adjusting the fourth height adjustment coupler.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

1. A hard surface cleaning appliance comprising:
a cleaning head with a top surface and a bottom surface, wherein the bottom surface is adjacent a surface to be cleaned;
a first attachment ear coupled to the top surface;
a second attachment ear coupled to the top surface;
and
an adaptor coupled to the first attachment ear and the second attachment ear, wherein the amount of pressure applied to the surface to be cleaned by the bottom surface is adjusted by the adjusting the adaptor.

2. The hard surface cleaning appliance of claim 1, wherein the adaptor comprises:
a first side bar coupled to the first attachment ear;
a second side bar coupled to the second attachment ear;
and
one or more than one cross member bar, wherein the one or more than one cross member bar couples the first side bar to the second side bar.

3. The hard surface cleaning appliance of claim 2, further comprising:
a first wheel coupled to the first side bar with a first height adjustable coupler;
a second wheel coupled to the first side bar with a second height adjustable coupler;
a third wheel coupled to the second side bar with a third height adjustable coupler;
and
a fourth wheel coupled to the second side bar with a fourth height adjustable coupler;
wherein the adaptor is adjusted in response to adjusting the height of
any of the first, second, third or fourth height adjustable couplers.

4. The hard surface cleaning appliance of claim 3, further comprising a handle, wherein the handle comprises:
a first handle bar, wherein the first handle bar is coupled to the first attachment ear;
and
a second handle bar, wherein the second handle bar is coupled to the second attachment ear.

5. The hard surface cleaning appliance of claim 4, wherein the first handle bar and the first side bar are coupled to opposing surfaces of the first attachment ear.

6. The hard surface cleaning appliance of claim 5, wherein the second handle bar and the second side bar are coupled to opposing surfaces of the second attachment ear.

7. The hard surface cleaning appliance of claim 6, wherein the first handle bar and the first side bar are coupled to opposing surfaces of the first attachment ear using a lynch pin, wherein the lynch pin extends through the first side bar, through the first attachment ear, and through the first handle bar.

8. A cleaning appliance comprising:
a cleaning head comprising:
a top surface;
and
a bottom surface, wherein the bottom surface is adjacent a surface to be cleaned; and
an adaptor coupled to the top surface, the adaptor comprising:
a frame;
one or more than one wheel;
and
one or more than one height adjustable coupler, wherein each of the one or more than one wheel is coupled to the frame using a corresponding one of the one or more than one height adjustable couplers;
wherein adjusting any of the one or more than one height adjustable couplers adjusts the amount of pressure the bottom surface applies to the surface to be cleaned.

9. The cleaning appliance of claim 8, wherein the cleaning head further comprises:
a first attachment ear;
and
a second attachment ear;
wherein the adaptor is coupled to a first attachment ear outer surface, and wherein the adaptor is coupled to a second attachment ear outer surface.

10. The cleaning appliance of claim 9, further comprising:
a first handle bar, wherein the first handle bar is coupled to a first attachment ear inner surface;
and
a second handle bar, wherein the second handle bar is coupled to a second attachment ear inner surface.

11. The cleaning appliance of claim 10, wherein the frame comprises:
a first side bar;
a second side bar;
and
a cross member, wherein the cross member couples the first side bar to the second side bar.

12. The cleaning appliance of claim 11, wherein at least one of the one or more than one height adjustable couplers comprises:
a threaded rod, wherein the threaded rod extends through the first side bar;
a first and a second nut, wherein the height of the first side bar above the surface to be cleaned is adjusted in response to adjusting the first and the second nut;
an axle, wherein one of the one or more than one wheels is coupled to the axle;
and
a wheel cover assembly, wherein the wheel cover assembly couples the axle to the threaded rod.

13. The cleaning appliance of claim 11, wherein the first side bar is coupled to the first attachment ear outer surface.

14. The cleaning appliance of claim 13, wherein the second side bar is coupled to the second attachment ear outer surface.

15. A method of forming a hard surface cleaning appliance comprising:
forming a cleaning head comprising an attachment ear;
forming a handle, wherein the handle couples to the attachment ear;
and
forming an adaptor, wherein the adaptor couples to the attachment ear.

16. The method of claim 15, wherein forming a cleaning head comprising an attachment ear comprises coupling an attachment ear to a top surface of the cleaning head.

17. The method of claim 15, wherein forming a cleaning head comprising an attachment ear comprises coupling a first and a second attachment ear to a top surface of the cleaning head.

18. The method of claim 15, wherein forming an adaptor, wherein the adaptor couples to the attachment ear, comprises the steps of:
forming a first and a second adaptor side bar;
and
coupling the first adaptor side bar to the second adaptor side bar with a first and a second cross member bar.

19. The method of claim 18, further comprising the steps of:
coupling a first wheel to the first adaptor bar with a first height adjustment coupler;
coupling a second wheel to the first adaptor bar with a second height adjustment coupler;
coupling a third wheel to the second adaptor bar with a third height adjustment coupler; and
coupling a fourth wheel to the second adaptor bar with a fourth height adjustment coupler.

20. The method of claim 19, wherein an amount of pressure exerted on a surface to be cleaned by the cleaning head is adjusted in response to adjusting the first height adjustment coupler.
